(19) United States
(12) Patent Application Publication
(10) Pub. No.: US 2014/0040431 A1
(43) Pub. Date: Feb. 6, 2014

(54) SYSTEMS AND METHODS FOR AN OPC UA SERVER

(71) Applicants: Dattaraj Jagdish Rao, Virginia Beach, VA (US); Ronald Ray Larson, Palm Bay, FL (US); Katrina Marie Griffith, Melbourne, FL (US); Stephen Daniel Tynor, Atlanta, GA (US)

(72) Inventors: Dattaraj Jagdish Rao, Virginia Beach, VA (US); Ronald Ray Larson, Palm Bay, FL (US); Katrina Marie Griffith, Melbourne, FL (US); Stephen Daniel Tynor, Atlanta, GA (US)

(73) Assignee: General Electric Company, Schenectady, NY (US)

(21) Appl. No.: 13/568,084

(22) Filed: Aug. 6, 2012

(51) Int. Cl. G06F 15/16

(52) U.S. Cl. 709/219

(57) ABSTRACT

A system includes an OPC UA server having a memory configured to provide an address space arranged into a plurality of reference nodes, in which each reference node is associated with data stored in a data source. The system further includes a processor configured to receive an OPC UA client request for the data associated with a particular reference node. The processor is also configured to request and receive from the data source the data associated with the particular reference node. The processor is further configured to reply to the OPC UA client request with the data received from the data source.

### BACKGROUND OF THE INVENTION

The subject matter disclosed herein relates to systems and methods for data storage and communication in servers implementing the OPC Unified Architecture (UA) protocol.

Certain systems, such as industrial automation systems, may include capabilities that enable the control and monitoring of the system. For example, an industrial automation system may include controllers, field devices, and sensors storing monitoring data for subsequent analysis. Furthermore, such industrial automation systems may include one or more devices that may be coupled to the controller and may communicate with other systems according to the OPC Unified Architecture (UA) protocol. OPC UA is a protocol for manufacturer-independent communication used in industrial automation systems (e.g., automated power generation systems and automated manufacturing systems) that is specified by the OPC Foundation. For example, an industrial automation system may include an OPC UA server that may generally store information regarding the operational parameters of the industrial automation system. Additionally, the OPC UA server may also make this information available, via a network connection, to one or more OPC clients operating at another location.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In an embodiment, a system includes an OPC UA server having a memory configured to provide an address space arranged into a plurality of reference nodes, in which each reference node is associated with data stored in a data source. The system further includes a processor configured to receive an OPC UA client request for the data associated with a particular reference node. The processor is also configured to request and receive from the data source the data associated with the particular reference node. The processor is further configured to reply to the OPC UA client request with the data received from the data source.

In another embodiment, a method includes monitoring a reference node in an address space of an OPC UA server and intercepting an OPC UA client request for data associated with the reference node. The method also includes requesting the data associated with the reference node from one or more data sources. The method further includes receiving the requested data from the one or more data sources; and sending the data received from the data source to the OPC UA client.

In another embodiment, a tangible, non-transitory, computer-readable medium stores a plurality of instructions executable by a processor of an electronic device, and the instructions include instructions to create a reference node in an address space. The reference node refers to data stored in a data source, and the data corresponds to a parameter of an industrial automation system. The instructions also include instructions to receive a client request directed to the reference node. The instructions further include instructions to request the data from the data source referred to by the reference node as well as instructions to receive the data from the data source. The instructions also include instructions to send the data received from the data source to the client.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of an industrial control system, including a controller, an OPC UA server, and an OPC UA client;

FIG. 2 is a block diagram of an embodiment of an OPC UA server system; and

FIG. 3 is a flow diagram illustrating an embodiment of a process by which the OPC UA server responds to OPC UA client requests.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As mentioned above, the OPC UA protocol is may be used in industrial automation systems, such as automated power generation systems (e.g., gas, steam, wind, or water turbines, heat recovery steam generators (HRSG), gasification systems, combustion systems, electrical power generators, or similar automated power generation systems) and automated manufacturing systems (e.g., chemical plants, oil refineries, or similar manufacturing system) to allow an OPC UA servers and OPC UA clients to communicate with one another over a network. That is, one or more OPC UA clients may utilize a number of OPC UA service calls over a network connection in order to send data to and receive data from an OPC UA server. In general, the OPC UA server may be disposed on-site, at the location of an industrial automation system (e.g., an automated manufacturing system, power generation system, gas turbine system, or other industrial automation system) and may manage data that is associated with the numerous operational parameters of the industrial automation system. For example, an OPC UA server may store a number of operational parameters (e.g., power output, applied voltages, revolution rates, fuel flow rates, or similar operational parameters) for an automated power generation system (e.g., a generator coupled to a wind turbine). While an OPC UA server may locally store these operational parameters in a local memory for subsequent OPC UA client access, for certain industrial automation systems, the number of operational parameters may become too large to efficiently store and serve the data in this manner.

Accordingly, the presently disclosed OPC UA server embodiments enable the use of one or more data sources (e.g., databases, data servers, or other similar data repositories) to store the data corresponding to the operational parameters of the industrial automation system. That is, the presently disclosed embodiments enable the use of reference nodes in the address space of the OPC UA server. In contrast to OPC UA nodes that actually store the operational parameter data associated with the node in the address space of the OPC UA server, the presently disclosed reference nodes each point or refer to the operational parameter data (e.g., stored on a data source) that is associated with each reference node. Furthermore, the presently disclosed embodiments include a Node Listener that may generally receive a request from an OPC UA client for data associated with a particular reference node, request and receive the data corresponding to the particular reference node from the data source, and send the data received from the data source to the OPC UA client. By using the disclosed reference nodes and Node Listener, the disclosed embodiments enable a lighter-weight OPC UA server (e.g., an OPC UA server that consumes fewer memory resources). As such, the lighter-weight OPC UA server embodiments presently disclosed may further enable the use of lower-capacity and/or lower-cost hardware to implement compared to the hardware utilized by OPC UA servers with local storage of parameters in each node. Moreover, present embodiments enable the use of reference nodes and data sources in a seamless manner, such that the OPC UA client requesting data associated with the particular node is unaware of the activities of the Node Listener. This means that the OPC UA protocol is generally compatible with the disclosed OPC UA server embodiments without modification.

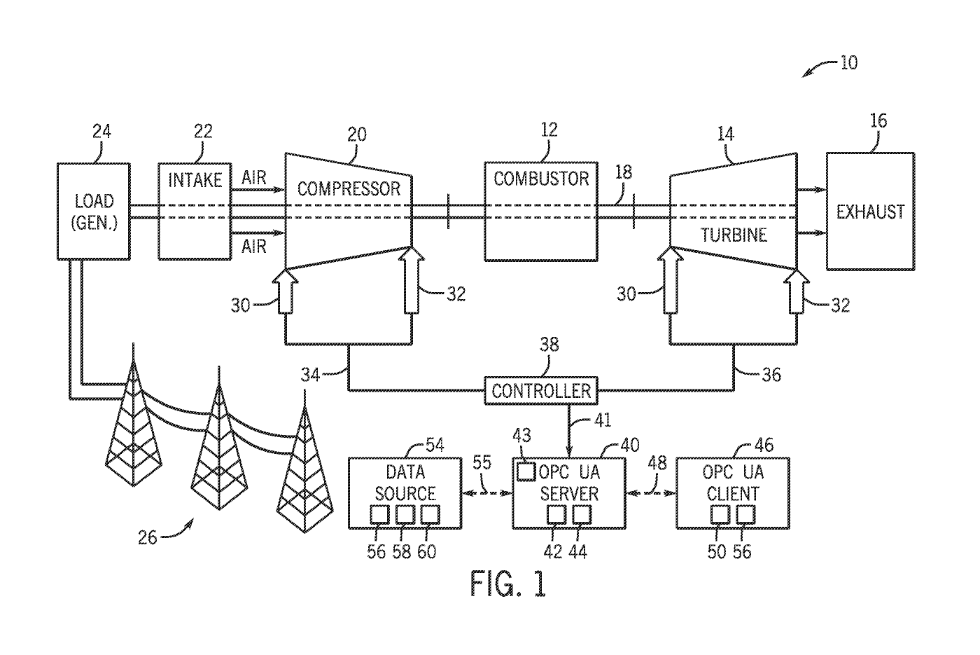

With the foregoing in mind, FIG. 1 illustrates a gas turbine system 10 as an example embodiment of an industrial automation system that incorporates techniques disclosed herein. As depicted, the turbine system 10 may include a combustor 12, which may receive a fuel/air mixture for combustion. This combustion creates hot, pressurized exhaust gases, which the combustor 12 directs through a turbine 14 (e.g., part of a rotor) and toward an exhaust outlet 16. As the exhaust gases pass through the turbine 14, the resulting forces cause the turbine blades to rotate a drive shaft 18 along an axis of the turbine system 10. As illustrated, the drive shaft 18 is connected to various components of the turbine system 10, including a compressor 20.

The drive shaft 18 may include one or more shafts that may be, for example, concentrically aligned. The drive shaft 18 may include a shaft connecting the turbine 14 to the compressor 20 to form a rotor. The compressor 20 may include blades coupled to the drive shaft 18. Thus, rotation of turbine blades in the turbine 14 may cause the shaft connecting the turbine 14 to the compressor 20 to rotate the blades within the compressor 20. The rotation of blades in the compressor 20 compresses air that is received via an air intake 22. The compressed air is fed to the combustor 12 and mixed with fuel to allow for higher efficiency combustion. The shaft 18 may also be connected to a load 24, which may be a vehicle or a stationary load, such as an electrical generator in a power plant or a propeller on an aircraft. When the load 24 is an electrical generator, the electrical generator may be coupled to a power grid 26 for distributing electrical power to, for example, residential and commercial users.

The turbine system 10 may also include a plurality of sensors and field devices configured to monitor a plurality of engine parameters related to the operation and performance of the turbine system 10. The sensors and field devices may include, for example, inlet sensors and field devices 30 and outlet sensors and field devices 32 positioned adjacent to, for example, the inlet and outlet portions of the turbine 14, and the compressor 20, respectively. The inlet sensors and field devices 30 and outlet sensors and field devices 32 may measure, for example, environmental conditions, such as ambient temperature and ambient pressure, as well as a plurality of engine parameters related to the operation and performance of the turbine system 10, such as, exhaust gas temperature, rotor speed, engine temperature, engine pressure, gas temperature, engine fuel flow, exhaust flow, vibration, clearance between rotating and stationary components, compressor discharge pressure, pollution (e.g., nitrogen oxides, sulfur oxides, carbon oxides and/or particulate count), and turbine exhaust pressure. Further, the sensors and field devices 30 and 32 may also measure actuator information such as valve position, and a geometry position of variable geometry components (e.g., air inlet).

The plurality of sensors and field devices 30 and 32 may also be configured to monitor engine parameters related to various operational phases of the turbine system 10. Measurements taken by the plurality of sensors and field devices 30 and 32 may be transmitted via module lines 34 and 36, which may be communicatively coupled to a controller 38. The controller 38 may use the measurements to actively control the turbine system 10. Further, the controller 38 and/or the sensors and field devices 30 and 32 may store the measurements (i.e., operational parameters of the industrial automation system 10) in a data source associated with an OPC UA server 40, as discussed in detail below. For example, module line 34 may be utilized to transmit measurements from the compressor 20, while module line 36 may be utilized to transmit measurements from the turbine 14. It should be appreciated that other sensors may be used, including combustor 12 sensors, exhaust 16 sensors, intake 22 sensors, and load 24 sensors. Likewise, any type of field devices may be used, including “smart” field devices such as Fieldbus Foundation, Profibus, and/or Hart field devices. It is also to be appreciated that the gas turbine system 10 is only an example embodiment of an industrial automation system, and that other industrial automation systems may include, for example, automated power generation systems, such as gas turbines, steam turbines, wind turbines, or hydroturbines, heat recovery steam generators (HRSG), a power generator, fuel skids, gas processing systems, or any other automated power generation system or partially-automated power generation system. Other industrial automation systems may include automated manufacturing systems such as chemical plants, pharmaceutical plants, oil refineries, automated production lines or similar automated or partially-automated manufacturing system.

As mentioned above, the OPC UA server 40 may be communicatively coupled to the controller 38 such that it may request and/or receive data from the controller 38 regarding the operational parameters of the system 10. In certain embodiments, the OPC UA server 40 may reside on-site (i.e., with the gas turbine system 10) or may be coupled to the controller 38 via a network connection (e.g., an internal network connection 41). That is, the OPC UA server 40 may include one or more networking interfaces 43 (e.g., Ethernet cards, wireless network cards, or similar networking devices) that may be used to communicatively couple the OPC UA server 40 to internal networks (e.g., internal to the site or the industrial automation system 10) or external networks (e.g., external to the site or the industrial automation system 10) for communication with other systems (e.g., the data source 54 and the OPC UA client 46). The operational parameters of the system 10 may include, for example, information regarding the status (e.g., functional, operational, malfunctioning, or similar status), the performance (e.g., the power output, revolutions per minute, load, or similar performance parameter), the environmental conditions (e.g., temperature, pressure, voltage, current, present or levels of a particular analyte, or similar environmental condition), and so forth, that may be generally tracked by the controller 38 for the industrial automation system, such as the gas turbine system 10.

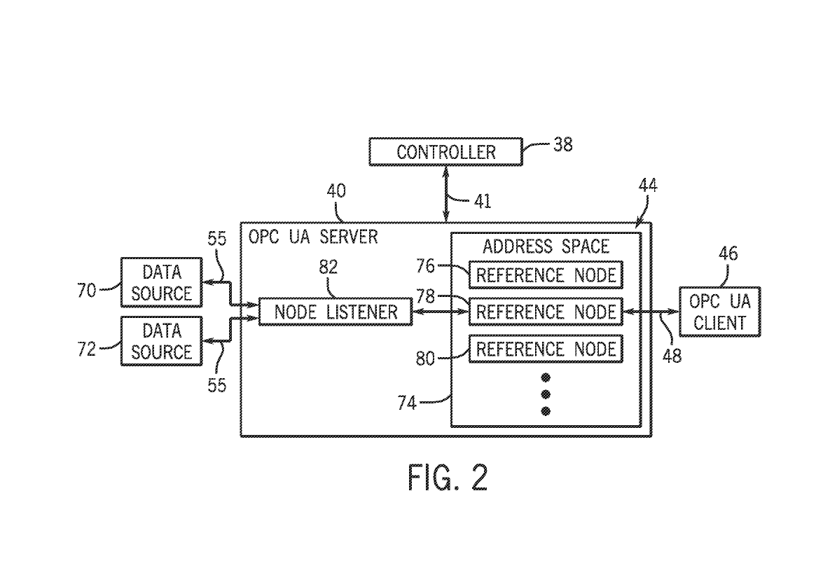

The OPC UA server 40 may include a processor 42 and memory 44 that may be used to execute instructions to control the operations of the OPC UA server 40. As discussed below with regard to FIG. 2, while the internal system of the disclosed OPC UA server embodiments (e.g., OPC UA server 40) stores and retrieves data in a manner different from typical OPC UA servers, OPC UA clients, such as OPC UA client 46, may generally communicate (e.g., using an external network connection 48) with the disclosed OPC UA server 40 according to the standard OPC UA protocol. For example, the OPC UA client 46 may include a processor 50 and memory 52 that may be used to execute instructions to send request for data according to the standard OPC UA protocol. Subsequently, as discussed in detail below with respect to FIG. 2, the illustrated OPC UA server 40 may request data from one or more data sources (e.g., data source 54) in order to fulfill the data requests of the OPC UA client 46.

In general, the data source 54 may be any type of data repository. For example, the data source 54 may be a database or other type of data server. Additionally, in certain embodiments, the data source 54 may reside on-site and communicatively coupled to the OPC UA server 40 (e.g., via internal network connection 55), or may be off-site and coupled to the OPC UA server 40 via an external network connection. In other embodiments, the data source 54 may reside on the same electrical device (e.g., computer, server, or similar processing or computing device) as the OPC UA server 40 and the communication may instead involve a local connection (e.g., local loop-back, common files or memory spaces, etc.).

The illustrated data source 54 includes a processor 56 and memory 58 that may be used to execute instructions to respond to requests for data from the OPC UA server 40. The data source 54 may further include one or more data storage media (e.g., hard drives, solid-state discs, optical media, tape media, or similar data storage media) that may be used to store the data provided by the OPC UA server 40. For example, during the operation of the gas turbine system 10, the OPC UA server 40 may provide data to the data source regarding the operational parameters of the gas turbine system 10 (e.g., as it is received from the controller 38). That is, as discussed in detail below, the OPC UA server 40 may create reference nodes that may generally serve as pointers or references to data stored in the data source 54 (e.g., in the memory 58 and/or data storage media 60) instead of storing the data locally (e.g., in memory 44 of the OPC UA server 40).

FIG. 2 is a block diagram depicting components of the OPC UA server 40 as well as the interactions of the OPC UA server 40 with the OPC UA client 46 and data sources 70 and 72. In particular, as illustrated in FIG. 2, the OPC UA server 40 includes an address space 74, which is generally defined within a portion of the memory 44. That is, the OPC UA server 40 may reserve a portion of memory 44 to define an address space 74 that includes a number of reference nodes (e.g., reference nodes 76, 78, 80) that may be organized into a hierarchical structure, based on the OPC UA standard protocol. It should be appreciated that while OPC UA servers may have an address space having nodes, present embodiments specifically utilize reference nodes (e.g., reference nodes 76, 77, and 80) that do not store operational parameters data for the industrial automation system 10, but rather store references or pointers to the operational parameter data that is instead stored in one or more data sources (e.g., data sources 70 and/or 72). It should further be appreciated that this enables the disclosed OPC UA server embodiments to be more light-weight (i.e., consume fewer memory resources), which may generally enable the use of lower capacity and lower-cost components (e.g., memory 44) to implement the OPC UA server 40. Furthermore, it should be noted that, while the disclosed OPC UA server embodiments utilize reference nodes, as described herein, certain embodiments may also employ a number of non-reference nodes (i.e., traditional nodes that actually store the values for the operational parameters of the industrial automation system) for at least a portion of the operational parameters managed by the OPC UA server 40.

In FIG. 2, each illustrated reference node (e.g., reference nodes 76, 78, and 80) stores one or more references to particular operational parameter data (e.g, for industrial automation system 10) stored in the data sources 70 and/or 72. These references may be a unique identifier that the data sources 70 and/or 72 may use to lookup the particular operational parameter data associated with each reference node 76, 78 and 80. For example, in certain embodiments, each reference nodes 76, 78, 80 may store a primary key value as a unique identifier, and a data source (e.g. data source 70 or 72) may utilize this primary key value to access a particular record from a database table storing the data associated with each reference node. In other embodiments, each reference nodes 76, 78, 80 may store a hash value as a unique identifier, and a data source (e.g. data source 70 or 72) may utilize this hash value to access a particular record from a hash table storing the data associated with each reference node. In still other embodiments, the reference nodes (e.g., reference nodes 76, 78, and 80) may each, for example, store a logical memory address (e.g., in memory 58 of data source 54) or a logical or physical location on a data storage medium (e.g., data storage medium 60 of data source 54) where the associated data is stored. Generally speaking, as operational parameter data reaches the OPC UA server 40 from the controller 38, the OPC UA server 40 may direct portions of the data to the one or more data sources (e.g., data sources 70 and/or 72) and may further define and/or assign the reference values for reference nodes (e.g., reference node 76, 78, 80, or new reference nodes) as they are indicated by the one or more data sources. That is, one or more data sources (e.g., data sources 70 and 72) may communicate back to the OPC UA server a reference value (e.g., a key value for a database table, a memory address, or a logical or physical location on a data storage medium, or similar reference value) that the OPC UA server 40 may later communicate to the one or more data sources to retrieve the data.

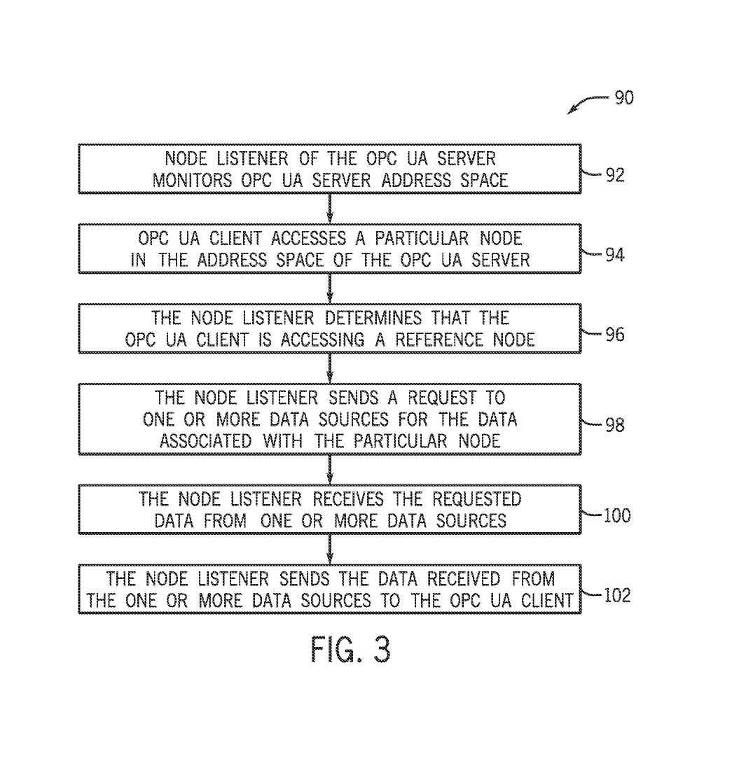

Additionally, the OPC UA server 40 includes a Node Listener 82 that may generally facilitate the retrieval of data from the data sources 70 and/or 72 based on requests from an OPC UA client 46. The Node Listener 82 is generally a set of instructions that may be stored in memory 44 and executed by the processor 42 (as illustrated in FIG. 1) of the OPC UA server 40. Accordingly, FIG. 3 is a flow diagram illustrating a process 90 by which the Node Listener 82 may facilitate the retrieval of operational parameter data for the industrial automation system 10, based on requests from an OPC UA client (e.g., OPC UA client 46). The process 90 begins with the Node Listener 82 of the OPC UA server 40 monitoring (block 92) the address space 74 of the OPC UA server 40. More specifically, the Node Listener 82 may monitor or listen to the various reference nodes (e.g., reference nodes 76, 78, and 80) to determine if an OPC UA client is attempting access.

At some point, an OPC UA client accesses (block 94) a particular node 78 in the address space 74 of the OPC UA server 40. The Node Listener 82, still monitoring the address space 74, may then determine (block 96) that the OPC UA client 46 is attempting to access reference node 78 and intercept the request. The Node Listener 82 may then send (block 98) a request to one or more data sources (e.g., data sources 70 and/or 72) for the data associated with the reference node 78 using reference value (e.g., a primary key value of a database table) for the reference node 78. Furthermore, it should be appreciated that, while the Node Listener 82 is requesting the data from data sources 70 and/or 72, the Node Listener 82 may generally ensure that the connection to the OPC UA client 46 is maintained until the data sources respond. Once the data sources (e.g., data source 70 and/or 72) have retrieved and sent the data associated with the reference node 78 based on the received reference value, the Node Listener 82 may receive (block 100) the requested data from the data sources that is associated with the reference node 78. The Node Listener 82 then seamlessly sends (block 102) the data received from the data sources 70 and/or 72 to the OPC UA client 46 as if the OPC UA client were directly accessing a node storing data (e.g., a non-reference node). Additionally, in certain embodiments, the OPC UA server 40 may subscribe an OPC UA client 46 to a particular reference node (e.g., reference node 78) such that, if the operational parameter data associated with the reference node changes (e.g., due to updated information from the controller 38), the OPC UA server 40 may automatically send the updated operational parameter data to the OPC UA client 46 (e.g., via an external network connection 48).

Technical effects of the presently disclosed embodiments include enabling a lighter-weight OPC UA server, which may generally operate in a more efficient fashion, utilize lower-capacity hardware, and/or utilize lower-cost hardware. Moreover, by moving at least a substantial portion of the data storage responsibilities to one or more data sources, the disclosed OPC UA server embodiments may be more robust to handle large volumes of operation parameter data for an industrial automation system. Furthermore, since the internal mechanisms presently disclosed for data storage and retrieval within the OPC UA are transparent to the OPC UA client, the presently disclosed embodiments are fully compatible with the OPC UA standard protocol.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
an OPC UA server, comprising:
a memory configured to provide an address space arranged into a plurality of reference nodes, and wherein each reference node is associated with data stored in a data source; and
a processor configured to:
receive an OPC UA client request for the data associated with a particular reference node;
request and receive from the data source the data associated with the particular reference node; and
reply to the OPC UA client request with the data received from the data source.

2. The system of claim 1, comprising a network interface configured to receive the OPC UA client requests over a network and to reply to the OPC UA client over the network.

3. The system of claim 2, wherein the network interface is configured request and receive, over the network, the data associated with the particular reference node from the data source.

4. The system of claim 1, wherein each reference node stores a unique identifier that corresponds to the data associated with each of the plurality of reference nodes.

5. The system of claim 4, wherein the data source is configured to use the unique identifier to retrieve the data associated with the particular reference node.

6. The system of claim 5, wherein the unique identifier comprises a database key value, a hash table value, a memory address, or a logical or physical location on a data storage medium of the data source.

7. The system of claim 1, comprising an industrial automation system, wherein the data stored in the data source corresponds to one or more operational parameters of the industrial automation system.

8. The system of claim 7, wherein the industrial automation system comprises a power generation system or an automated manufacturing system.

9. The system of claim 7, wherein the industrial automation system comprises a gas turbine system, an integrated gasification combined cycle (IGCC) system, a steam turbine system, a wind turbine system, a water turbine system, a power generation system, or any combination thereof.

10. The system of claim 1, comprising an OPC UA client comprising a memory and a processor configured to:
send the OPC UA client request to the OPC UA server for the data associated with the particular reference node; and
receive from the OPC UA server the data associated with the particular reference node.

11. A method, comprising:
monitoring a reference node in an address space of an OPC UA server;
determining that an OPC UA client is accessing the reference node;
requesting the data associated with the reference node from one or more data sources;
receiving the requested data from the one or more data sources; and
sending the data received from the data source to the OPC UA client accessing the reference node.

12. The method of claim 11, wherein requesting the data associated with the reference node comprises requesting the data associated with the reference node from the one or more data sources over a network.

13. The method of claim 11, wherein requesting the data associated with the reference node comprises providing the one or more data sources with a unique identifier that is associated with the reference node.

14. The method of claim 11, wherein the one or more data sources comprises one or more databases or data servers.

15. The method of claim 11, wherein the data received from the data source corresponds to one or more operational parameters of a power generation system or an automated manufacturing system.

16. A tangible, non-transitory, computer-readable medium storing a plurality of instructions executable by a processor of an electronic device, the instructions comprising:
instructions to create a reference node in an address space, wherein the reference node refers to data stored in a data source, wherein the data corresponds to a parameter of an industrial automation system;
instructions to receive a client request directed to the reference node;
instructions to request the data from the data source referred to by the reference node;
instructions to receive the data from the data source; and
instructions to send the data received from the data source to the client.

17. The medium of claim 16, wherein the client request is received via an external network connection, and wherein the data received from the data source is sent to the client over the external network connection.

18. The medium of claim 16, wherein the data from the data source is requested and received over an internal network connection.

19. The medium of claim 16, wherein the reference node refers to the data stored in the data source using a reference value that corresponds to the data associated with the reference node.

20. The medium of claim 16, wherein the client comprises an OPC UA client and the server comprises an OPC UA server.
